(19) United States
(12) Patent Application Publication
(10) Pub. No.: US 2015/0202469 A1
(43) Pub. Date: Jul. 23, 2015

(54) Non-winding type high-storey rescue lift

(71) Applicant: Guangtian LIU, (US)

(72) Inventors: Guangtian Liu, Liaoning (CN); Jinlong Sha, Liaoning (CN); Qingwu Wang, Liaoning (CN); Zhengde Zhou, Liaoning (CN)

(21) Appl. No.: 14/411,916

(22) PCT Filed: Mar. 26, 2013
(86) PCT No.: PCT/CN2013/073203

§ 371 Date: Dec. 30, 2014

(30) Foreign Application Priority Data
Jul. 23, 2012 (CN) 201210254212.3

(51) Int. Cl. A62B 1/02

(52) U.S. Cl. CPC A62B 1/02

(57) ABSTRACT

Disclosed is a non-winding type high-storey rescue lift, comprising a car shifting mechanism, an apparatus preventing the steel cable track and the car from drifting, a speed reducing and damping apparatus, two pairs of movable pulleys distributed in a cross shape, an apparatus for pre-placing a car, a speed limiting and braking apparatus and a storey selection apparatus. The non-winding type high-storey rescue lift is provided with multiple protection measures, is suitable for rescue from high storeys and is passive.

### BACKGROUND OF THE INVENTION

The invention refers to a rescue device for high-rise buildings, which is an elevator used to rescue the trapped people from high-rise building in calamity, and this rescue device has no electric drive.

So far, most of the non-electric-driving rescue elevators for high-rise building are winding, which means the haulage cable pulling compartment A (or escape capsule A) winds forwardly on the roller, and the haulage cable pulling compartment B (or escape capsule B) winds backwardly on the roller. One of the compartment moves downward by the gravity, and the other moves upward at the same time. Practically, the haulage cable (use steel cable, similarly hereinafter) moves fast at first and decelerates afterwards. The speed is a variety, but usually it is obtained by an average value. It causes interference resulting in a safety hazard. Therefore, this type of winding elevators are used as freight elevators only under the national rules.

CN202078661 U published a descent control device for high altitude, as it uses as non-winding type high-storey rescue lift. It published the elevator with the device of two opposite-directed haulage cables pulling two compartments respectively, but the CN202078661 U published only a part of the non-winding type high-storey rescue lift.

### BRIEF SUMMARY OF THE INVENTION

The purpose of the invention is to provide a type of non-winding type high-storey rescue lift including CN202078661 U. The part published by CN202078661 U is called compartment pulling system.

The purpose of the invention is accomplished by: compartments traction system includes the driving wheels of the deceleration damping device, the fixed two-pair free pulley and coiling wheel on the top of each compartment. The characters are listed as follows.

The elevator compartment cabin displacement device includes the frame on its base, two compartment cabins inside the frame. One compartment is installed in each compartment cabin underneath which there is a hatch working as the entrance of the compartment. There are at least two longitudinal guide rails installed underneath each of the compartment cabins, and all the rails are connected rigidly on the upper surface of the base matching a set of longitudinal pulleys, so a longitudinal guide rail is positioned at a set of longitudinal pulleys. The rotational shaft key on the handle is connected to the input shaft of the handle decelerator. The output shaft of the handle decelerator is connected to the main sprocket shaft. The handle, handle decelerator and the main sprocket are installed on the handle stand. The left-sprocket and right-sprocket are installed respectively on both sides of the front part of the handle stand. The handle stand is installed on the base, with the exactly same sprockets on each side, and each sprocket is smaller than the main sprocket. The both ends of the moving chain are fixed at one of the guide rails, so the part in-between meshes with the left-sprocket, the main sprocket and the right-sprocket accordingly. The base is installed at the edge of roof of the building. In the rescue mode, the handle is to be pulled to make the main sprocket drive the chain moving outward, then the guide rail moving outward, there movable compartment cabin moving outward until the two entrances go beyond the edge of the roof of the building, for descending the compartments. When the rescue ends, the handle is to be pulled backward to move the compartments inward back to the base.

The anti-lock device is located between the steel rope track and the compartments. Use rope tracks for ascending and descending of the compartments. The invention is an emergency rescue device, not a common facility. Therefore the tracks are not rigid fixed, but the foldable rope tracks are used. To prevent shifting of the rope tracks during the ascending and descending of the compartments, the anti-lick device between the steel rope track and the compartments is applied, which includes: a U-beam installed at each side (left and right) of the compartment cabin and each u-beam has a dovetail-shaped bottom, several I-shaped pulleys are installed at each side of each compartment, the u-beams work as enclosed tracks of the pulleys, a flanged track is installed at the outer surface of beam wall of each u-beam as a secondary track, an I-shaped hand wheel is installed at the outer surface of the bottom of each u-beam, the starting end of the wire cable is wound to a I-shaped pulley. The guide device includes: a hole is drilled to penetrate by the cable at the web of the upside-downed-T-shaped base, and a bearing pedestal is installed at each side of the flange of the T-shaped base an I-shaped pulley is installed at each of the bearing pedestal, with the axial direction according to the direction of the web of the base. The guide device is at the top of the uppermost 1-shaped pulley, and the two flanged tracks mesh with the two 1-shaped pulleys, respectively, so the guide device across from one of the secondary track to the other. The steel rope track uncoils from the 1-shaped pulley hand wheel, meshes with the fixed pulley on the U-beam, penetrates through the hole on the guide device, then meshes with several pulleys one by one from top to bottom. Attach a hook at the end of each steel rope for hooking with a hook fixed on the ground. When the elevator compartment cabin displacement device displaces the cabins until the entrances completely beyond the edge of the roof of the building, the four steel tope tracks need to be put down and fixed to the ground: rotate the four I-shaped hand wheels to make the four tracks shifted down to the hooks on the ground, hook the hooks at the ends of the tracks to the hooks fixed on the ground. In this way, the enclosed space is created between the u-beam and the I-shaped pulleys to prevent shifting of the steel rope tracks.

In the compartment pulling system, the driving wheel key is connected to the main shaft, the driving wheels of the deceleration damping device A includes an accelerating transmission and a load wheel which is installed on the outer collar of the bearing of the output bearing of the transmission. The load wheel includes axial round eaves on its circumference and two fan-shaped friction plates whose centers overlap with each other on the plate base and are connected with two springs. The outline of the plate base fills the gap between the two friction plates. The plate base key-joins to the output shaft of the transmission. There is space between the edge of the plates and the eave. The input shaft of the transmission is key joined to the input gear, which meshes the connecting gear on the main shaft. When the main shaft rotating speed which is also the descending speed of the compartment is normal, the rotating speeds of the plate base and the two friction plates are normal. The springs in-between pulling the two friction plates keeps the plates still so that the load wheel is still on the bearing pedestal. When the main shaft rotating speed which is also the descending speed of the compartment is too high, through the transmission, increase the speed of the friction plates. Under the centrifugal force, the plates overcome the pulling force from the springs and move outward toward the eave. The friction between the eave and the plates rotate the load wheel to increase the system loading, limit the increase of the rotating speed of the main shaft, and slow down the rotation.

In the compartment pulling system, the so-called pair of free pulleys fixed on the top of the compartment is installed crosswise in order to keep the compartment leveled during the ascending and descending.

Pre-release one of the compartments device. The non-operating state (not in use) of the invention is: the two compartments are still in the cabin. The operating state of the invention is: one of the two compartments is up and the other is down. They are counter-weight of each other. Therefore, after releasing one of the compartments, compartment A, to the ground, the invention gets into operation. The pre-release one of the compartments device includes: in the compartment pulling system, the shaft of the coiling wheel key joins to the gear A, gear A meshes with the input gear of the transmission of the deceleration damping device B(same as the deceleration damping device A).

The pre-release one of the compartments device also includes manual switches with one switch for each compartment. Each switch includes: an up-side-down L-shaped hook is installed at the top of each compartment, a J-shaped lever hook is pin joined at the ceiling of the compartment cabin, and the locations of the J-shaped hooks match with the locations of the L-shaped hooks. The load point of the lever is pin-joined to a connecting bar, and the other end of the connecting bar connects to the effort point of the J-shaped lever hook. When the invention is not in operation, every compartment cabin hook hooks with its corresponding compartment hook, and both compartments are fixed inside the compartment cabin.

After the hooks at the ends of the four steel ropes hook with the corresponding ground hooks, release the compartment A first. To release the compartment A, push the bottom of the lever on the compartment A outward, then the upper part of the lever will pull the top of the connecting bar and the compartment cabin hook inward, then the compartment cabin hook will move outward, separating from the compartment hook. The I-shaped pulleys at the sides of the compartment A move downward in gravity according to the U-beam track. When the I-shaped pulleys leave the u-beam, the guide device is stuck at the dovetail bottom of the u-beam. The I-shaped pulleys continue to move to the ground. In the whole descending process of the compartment A, its coiling wheel rotates to release the rope. The gear A on the coiling wheel drives the input gear of the decelerating damping device transmission. The decelerating damping device works to prevent the high descending speed of the compartment A. The switches designed to be manual is also to prevent false switching that makes the compartment fall by mistake.

When the evacuees ride on compartment B in descending, the compartment A is in ascending. When the compartment A ascends to the bottom of the u-beam track, the guide device guides the I-shaped pulleys of the compartment A into the u-beam track. Getting into the track, the compartment A continues to ascend, with the guide device on its top, to the compartment cabin, which is the same as the compartment B.

To operate safely, the invention includes a speed limit brake device. Install a speed meter on any of the fixed pulleys in the compartment pulling system. The pulley key joins with its shaft. The shaft of the fix pulley and the inner collar of the shaft fit perfectly. The bearing is installed on the pedestal. The driving bearings of the speed meter is rigidly connected to the bearings of the fixed pulleys. The speed meter set as the limit speed is smaller than the braking speed. Fix a speed limit reed switch at the speed limit calibration and a brake reed switch at the braking calibration. The needle on the meter is magnetic. Install a large DC electromagnetic brake on the main shaft. As its large braking force, it is used as a breakage. Install a small DC electromagnetic brake on the main shaft. As its small braking force, it is used as a speed limiter. The speed limit reed switch works as a switch connecting into the control circuit of the small DC electromagnetic brake which is the speed limiter, and the brake reed switch works as a switch connecting into the control circuit of the large DC electromagnetic brake which is the breakage. When the rotating speed reaches the pre-set limit speed, the magnetic needle in the meter points to the speed limit calibration, turning the speed limit reed switch off. After the power is cut off, the speed limiter stops the shaft. When the device is out of order, the rotation speed increases instead of decreasing, and the needle points to the braking calibration to turn the brake reed switch off. After the power is cut off, the breakage stops the shaft, and the whole system stops running.

The floor selecting device includes: the main shaft driving the screw through the sprocket transmission system, several travel switches installed along the axial direction of the screw. All the travel switches are connected into the control circuit of the breakage in parallel. Install bolt caps on the screw as link stoppers of the travel switches. The distance a bolt cap travels between two adjacent travel switches corresponds to the distance the compartment travels between two adjacent floors. The number of the travel switches equals to the number of floors. Every travel switch has its corresponding floor. After pressing the button is pressed to choose an actual floor to stop, the corresponding travel switch receives the signal, the link stopper bumps with the travel switch, the travel switch is cut off to make breakage stop the main shaft, and the compartment stops at the selected floor.

Comparing with current technology, the advantage of the invention is that it provides a complete non-winding type high-storey rescue lift, which has been proved through practice Another advantage is that the multiple safeguard protection improves its reliability, safety, comfort level and usefulness.

### BRIEF DESCRIPTION OF THE DRAWINGS

FIG. 1 is the figure of the invention not in use.

FIG. 2 is the left elevation of the invention.

FIG. 3 is the auxiliary view A of the invention.

FIG. 4 is the B-B sectional plan of the invention.

FIG. 5 is the view of left compartment in FIG. 2.

FIG. 6 is the enlarged view of part D in FIG. 5.

FIG. 7 is the plan view of FIG. 6.

FIG. 8 is the enlarged view of part C in FIG. 5.

FIG. 9 is the view of right compartment in FIG. 8.

FIG. 10 is the upward view of FIG. 9.

FIG. 11 is the enlarged view of part E in FIG. 2.

FIG. 12 is the longitudinal sectional view of the decelerating damping device A(25) in FIG. 11.

FIG. 13 is the auxiliary view of F in FIG. 12.

FIG. 14 is the auxiliary view of G in FIG. 5.

FIG. 15 is the figure of the speed limit brake device.

FIG. 16 is the figure of the floor selecting device.

### DETAILED DESCRIPTION OF THE INVENTION

The invention includes:

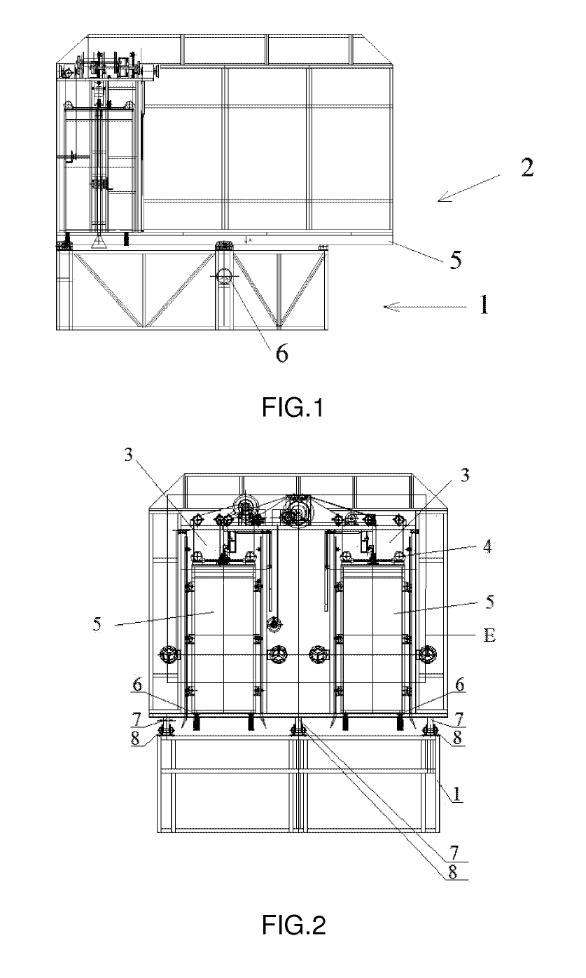

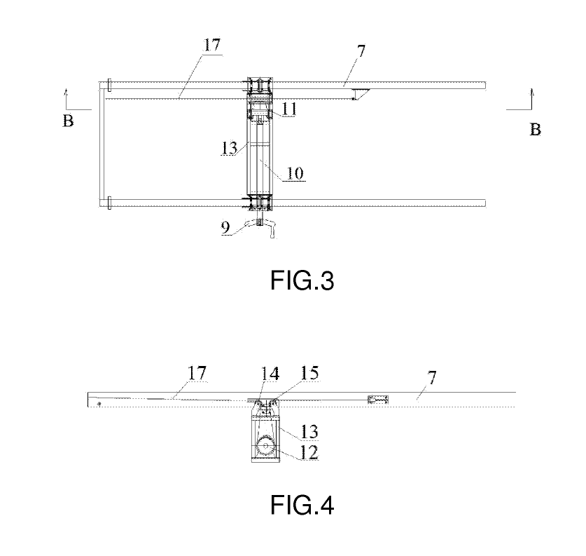

1. the elevator compartment cabin displacement device (see FIGS. 1 and 2) includes the frame(2) on its base(1), two compartment cabins (3) inside the frame. One compartment(5) is installed in each compartment cabin underneath which there is a hatch working as the entrance(6) of the compartment. There are at least two longitudinal guide rails(7) installed underneath each of the compartment cabins, and all the rails are connected rigidly on the upper surface of the base matching a set of longitudinal pulleys(8), therefore a longitudinal guide rail is positioned at a set of longitudinal pulleys. (see FIGS. 3 and 4) The rotational shaft key(10) on the handle(9) is connected to the input shaft of the handled decelerator(11). The output shaft of the handle decelerator is connected to the main sprocket shaft(12). The handle, handled decelerator and the main sprocket are installed on the handle stand(13). The left-sprocket(14) and the right-sprocket(15) are installed on the left front side and the right front side of the handle stand, respectively. The handle stand is installed on the base, with the exactly same sprockets on each side, and each sprocket is smaller than the main sprocket. The front and base ends of the moving chain(17) are fixed at one of the guide rails, so that the part in-between meshes with the left-sprocket, the main sprocket and the right-sprocket accordingly. The base is installed at the edge of the building's roof. In the rescue mode, pull the handle to make the main sprocket drive the chain moving outward, then the guide rail moves outward, and there movable compartment cabin moves outward until the two entrances go beyond the edge of the building's roof, to descend the compartments. When the rescue ends, pull the handle backward to move the compartments inward back to the base.

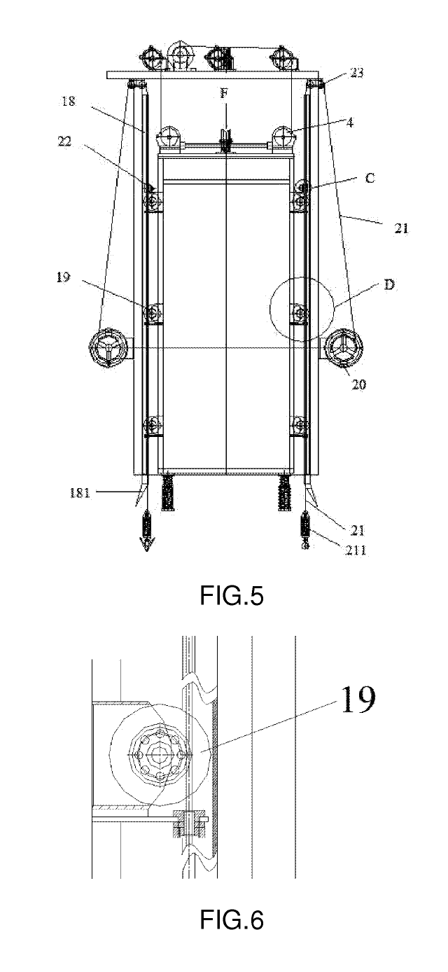

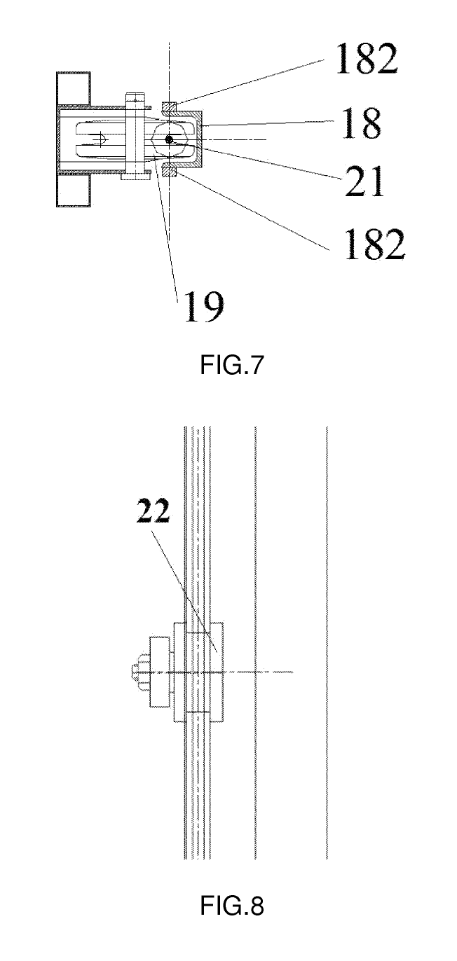

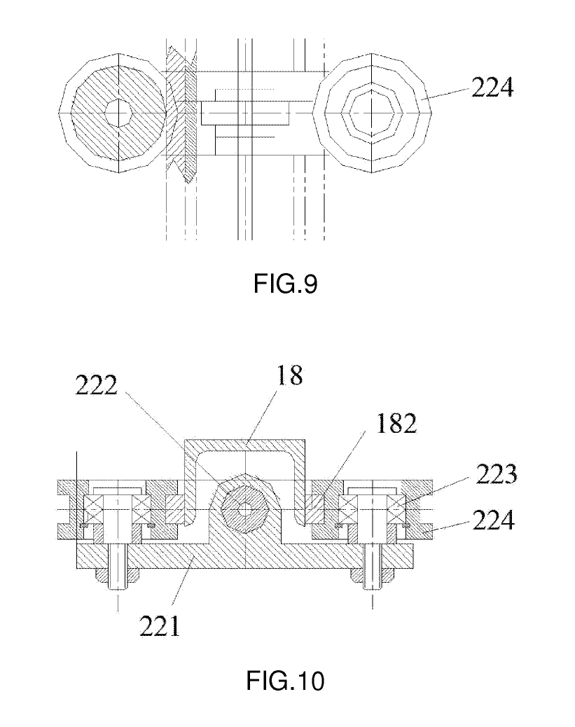

2. The anti-lock device between the steel rope track and the compartments. Use rope tracks for ascending and descending of the compartments. The invention is an emergency rescue device, not common facility. Therefore, the tracks are not rigidly fixed, but in a foldable manner. To prevent shifting of the rope tracks during the ascending and descending of the compartments, the anti-lick device between the steel rope track and the compartments is applied, it includes: (see FIG. 5 through 7) a U-beam(18) is installed at each side (left and right) of the compartment cabin and each u-beam has a dovetail-shaped bottom(181). Several I-shaped pulleys(19) are installed at each side of each compartment, and the u-beams work as enclosed tracks of the pulleys. A flanged track(182) is installed at the outer surface of beam wall of each u-beam as a secondary track. An I-shaped hand wheel(20) is installed at the outer surface of the bottom of each u-beam. The starting end of the wire cable(21) is wound to an I-shaped pulley. The guide device(22) includes: (see FIG. 8 through 10) a hole(222) which is penetrated by the cable at the web of the upside-downe-T-shaped base(221), and a bearing pedestal(223) is installed at each side of the flange of the T-shaped base. An I-shaped pulley(224) is installed at each of the bearing pedestal, with the axial direction according to the direction of the web of the base. The guide device is at the top of the uppermost I-shaped pulley, the two flanged tracks mesh with the two I-shaped pulleys, respectively, so the guide device across from one of the secondary track to the other. The steel rope track uncoils from the I-shaped pulley hand wheel, meshes with the fixed pulley(23) on the U-beam, penetrates through the hole on the guide device, and meshes with several pulleys one by one from top to bottom. Attach a hook(211) at the end of each steel rope for to hook with a hook fixed on the ground. When the elevator compartment cabin displacement device displaces the cabins until the entrances completely move beyond the edge of the building's roof, the four steel tope tracks need to be put down and fixed to the ground: rotate the four I-shaped hand wheels to make the four tracks shift down to the hooks on the ground, hook the hooks at the ends of the tracks to the hooks fixed on the ground, that way enclosed space is created between the u-beam and the I-shaped pulleys to prevent shifting of the steel rope tracks.

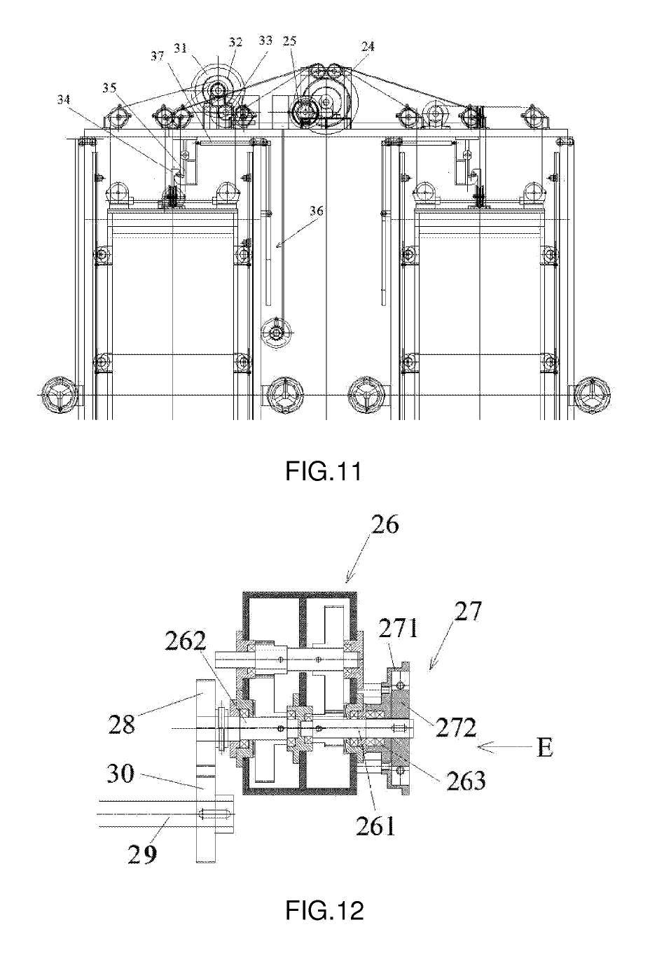

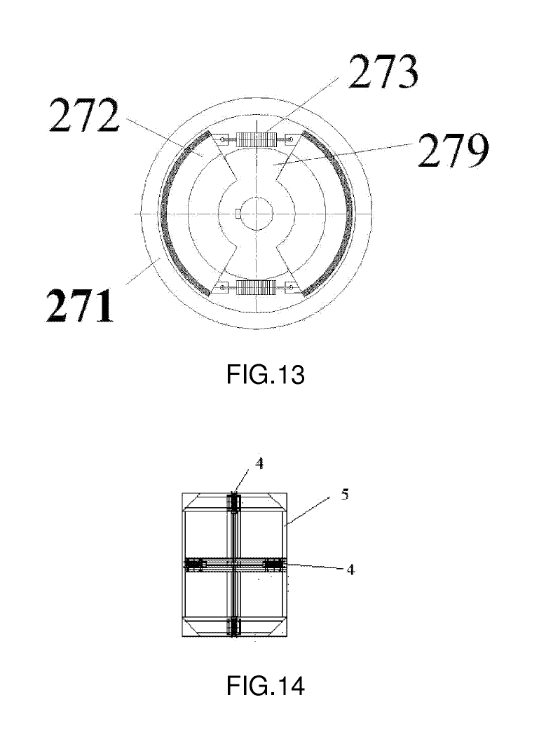

3. In the compartment pulling system, the driving wheel(24) key is connected to the main shaft, (see FIG. 11 through 13) and the driving wheels of the deceleration damping device A(25) includes accelerating transmission(26) and a load wheel(27) which is installed on the outer collar of the bearing(263) of the output bearing(261) of the transmission. The load wheel includes axial round eaves(271) on its circumference and two fan-shaped friction plates(272) whose centers overlap with each other on the plate base(274) and connected with two springs(273). The outline of the plate base fills the gap between the two friction plates. The plate base key-joins to the output shaft of the transmission. There is space between the edge of the plates and the eave. The input shaft(262)of the transmission is key joined to the input gear(28), which meshes the connecting gear(30) on the main shaft(29). When the main shaft rotating speed which is also the descending speed of the compartment is normal, the rotating speeds of the plate base and the two friction plates are normal. The springs in-between pulling the two friction plates keep the plates still, so that the load wheel is still on the bearing pedestal. When the main shaft rotating speed which is also the descending speed of the compartment is too high, through the transmission, increase the speed of the friction plates. Under the centrifugal force, the plates overcome the pulling force from the springs and move outward toward the eave. The friction between the eave and the plates rotate the load wheel to increase the system loading, limit the increase of the rotating speed of the main shaft, and slow down the rotation.

4. In the compartment pulling system, the so called two pairs of free pulleys(4) fixed on the top of the compartment is installed crosswise (see FIG. 14) in order to keep the compartment leveled during the ascending and descending.

5. Pre-release one of the compartments devices. The non-operating state (not in use) of the invention is that the two compartments are still in the cabin. The operating state of the invention is that one of the two compartments is up and the other is down. They are counter-weight of each other. Therefore, after releasing one of the compartments, compartment A, to the ground, the invention gets into operation.

The pre-release one of the compartments device includes: in the compartment pulling system, the shaft of the coiling wheel(31) key joins to the gear A, gear A meshes with the input gear of the transmission of the deceleration damping device B(33)(same as the deceleration damping device A). The pre-release one of the compartments device also includes a manual switches with one switch for each compartment. Each switch includes: a up-side-down L-shaped hook(34) installed at the top of each compartment, a J-shaped lever hook(35) pin joined at the ceiling of the compartment cabin, the locations of the J-shaped hooks matching with the locations of the L-shaped hooks. The load point of a lever pulling bar(36) is pin-joined to a connecting bar(37), and the other end of the connecting bar connects to the effort point of the J-shaped lever hook. When the invention is not in operation, every compartment cabin hook hooks with its corresponding compartment hook, and both compartments are fixed inside the compartment cabin.

After the hooks at the ends of the four steel ropes hook with the corresponding ground hooks, release the compartment A first. To release compartment A, push the bottom of the lever on the compartment A outward, then the upper part of the lever will pull the top of the connecting bar and the compartment cabin hook inward, then the compartment cabin hook will move outward, separating from with compartment hook. The I-shaped pulleys at the sides of the compartment A move downward in gravity according to the U-beam track. When the I-shaped pulleys leave the u-beam, the guide device is stuck at the dovetail bottom of the u-beam. The I-shaped pulleys continue to move to the ground. In the whole descending process of the compartment A, its coiling wheel rotates to release the rope. The gear A on the coiling wheel drives the input gear of the decelerating damping device transmission. The decelerating damping device works to prevent the high descending speed of the compartment A. The switches designed to be manual is also to prevent false switching that makes the compartment fall by mistake.

When the evacuees ride on compartment B in descending, the compartment A is in ascending. When the compartment A ascends to the bottom of the u-beam track, the guide device guides the I-shaped pulleys of the compartment A into the u-beam track. Getting into the track, the compartment A continues to ascend, with the guide device on its top, to the compartment cabin, which is the same as the compartment B.

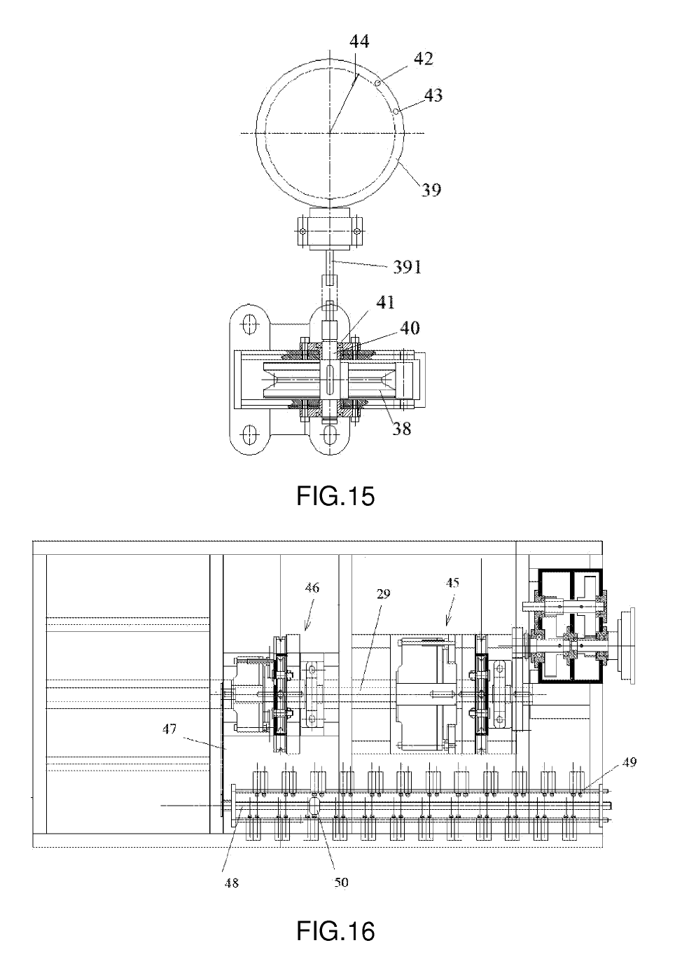

6. To operate safely, the invention includes a speed limit brake device.(see FIG. 15)Install a speed meter(39) on any of the fixed pulleys(38) in the compartment pulling system. The pulley key joins with its shaft. The shaft(40) of the fix pulley and the inner collar of the shaft(41) fit perfectly. The bearing is installed on the pedestal. The driving bearings(391) of the speed meter is rigidly connected to the bearings of the fixed pulleys. The speed meter set as the limit speed is smaller than the braking speed. Fix a speed limit reed switch(42) at the speed limit calibration and a brake reed switch(43) at the braking calibration. The needle(44) on the meter is magnetic. (see FIG. 16)Install a large DC electromagnetic brake(45) on the main shaft(29). As its large braking force, it is used as a breakage. Install a small DC electromagnetic brake(46) on the main shaft(29). As its small braking force, it is used as a speed limiter. The speed limit reed switch works as a switch connecting into the control circuit of the small DC electromagnetic brake which is the speed limiter, and the brake reed switch works as a switch connecting into the control circuit of the large DC electromagnetic brake which is the breakage. When the rotating speed reaches the pre-set limit speed, the magnetic needle in the meter points to the speed limit calibration, turning the speed limit reed switch off. After the power is cut off, the speed limiter stops the shaft. When the device is out of order, the rotation speed increases instead of decreasing, and the needle points to the braking calibration turning the brake reed switch off. After the power is cut off, the breakage stops the shaft, and the whole system stops running.

7. The floor selecting device includes(see FIG. 16): the main shaft (29) driving the screw(48) through the sprocket transmission system(47), several travel switches(49) installed along the axial direction of the screw. All the travel switches are connected into the control circuit of the breakage in parallel. Install bolt caps(50) on the screw as link stoppers of the travel switches. The distance a bolt cap travels between two adjacent travel switches corresponds to the distance the compartment travels between two adjacent floors. The number of the travel switches equals to the number of floors. Every travel switch has its corresponding floor. After the button is pressed to choose an actual floor to stop, the corresponding travel switch receives the signal, the link stopper bumps with the travel switch, the travel switch is cut off to make breakage stop the main shaft, and the compartment stops at the selected floor.

What is claimed is:

1. A non-winding type high-storey rescue lift includes the driving wheels of the deceleration damping device A, the fixed two-pair free pulley and coiling wheel on the top of each compartment, the characters are:
the elevator compartment cabin displacement device includes the frame on its base, two compartment cabins inside the frame, One compartment is installed in each compartment cabin underneath which there is a hatch working as the entrance of the compartment, At least two longitudinal guide rails are installed underneath each of the compartment cabins, and all the rails are connected rigidly with each other, and on the upper surface of the base a set of longitudinal pulleys is installed to match with the set of longitudinal rails, That means a set of longitudinal guide rail is positioned on the top of a set of longitudinal pulleys, The rotational shaft key on the handle is connected to the input shaft of the handle decelerator, The output shaft of the handle decelerator is connected to the main sprocket shaft, The handle, the handle decelerator and the main sprocket are installed on the handle stand, The left-sprocket and the right-sprocket are respectively installed on each side of the front part of the handle stand, The handle stand is installed on the base, with the exactly same sprockets on each side, and each sprocket is smaller than the main sprocket, The both ends of the moving chain are fixed at one of the guide rails, so the middle part engages with the left-sprocket, the main sprocket and the right-sprocket accordingly, The base is installed at the edge of roof of the building;
The anti-lock devices are installed between a steel rope track and a compartment: A U-beam is installed at each side (left and right) of the compartment cabin, and each u-beam has a dovetail-shaped bottom, Several I-shaped pulleys are installed at each side of each compartment, and the U-beams work as enclosed tracks of the pulleys, A flanged track is installed at the outer surface of beam wall of each u-beam as a secondary track, An I-shaped hand wheel is installed at the outer surface of the bottom of each U-beam, The starting end of the wire cable is wound to an I-shaped pulley, A guide device is installed at each wire cable to guide the I-shaped pulley to the wire cable track, The guide device includes: a hole which is penetrated by the cable at the web of the upside-downed-T-shaped base, and a bearing pedestal installed at each side of the flange of the T-shaped base, an I-shaped pulley installed at each bearing pedestal with the axial direction according to the direction of the web of the base, The guide device is at the top of the uppermost I-shaped pulley, and the two flanged tracks engages with the two I-shaped pulleys, respectively, so the guide device is set across from one of the secondary track to the other, The steel rope track uncoils from the I-shaped pulley hand wheel, meshes with the fixed pulley on the U-beam, penetrates through the hole on the guide device, then meshes with several pulleys one by one from top to bottom, The end of the steel rope attached to a hook hooked with a hook fixed on the ground;
In the compartment pulling system, the driving wheel key is connected to the main shaft, the driving wheels of the deceleration damping device include accelerating transmission and a load wheel which is installed on the bearing pedestal of the output bearing of the transmission, The load wheel includes axial round eaves on its circumference and two fan-shaped friction plates whose centers overlapped installed on the plate base and connected with two springs, The outline of the plate base fill the gap between the two friction plates, The input bearing key is connected to the input gear, which meshes the connecting gear on the main bearing;
In the compartment pulling system, the two pairs of the free pulleys are installed crosswise on the top of each compartment;
The pre-release one of the compartments device includes the coiling wheel of the compartment pulling device connected to gear A, The gear A meshes with the input gear of the transmission of the deceleration damping device B;
Pre-release one of the compartments device also includes manual switches with one manual switch for each of the compartments, A manual switch includes an up-side-down L-shaped hook is installed at the top of each compartment, a J-shaped lever hook pin-joined at the ceiling of the compartment cabin with the locations of the J-shaped hooks match with the locations of the L-shaped hooks, The load point of the lever pin-joined to a connecting bar, and the other end of the connecting bar connects to the effort point of the J-shaped lever hook;
The speed limit brake works in this way, A speed meter is installed on any of the fixed pulleys in the compartment pulling system, The pulley key joins with its shaft, The shaft of the fix pulley and the inner collar of the shaft fit perfectly, The bearing is installed on the pedestal, The driving bearings of the speed meter is rigidly connected to the bearings of the fixed pulleys, The speed meter is set as the limit speed which is smaller than the braking speed;
The floor selecting device includes: the main shaft driving the screw through the sprocket transmission system, several travel switches installed along the axial direction of the screw, All the travel switches are connected into the control circuit of the breakage in parallel, Install bolt caps on the screw as link stoppers of the travel switches, The distance a bolt cap travels between two adjacent travel switches corresponds to the distance the compartment travels between two adjacent floors, The number of the travel switches equals to the number of floors, Every travel switch has its corresponding floor, After pressing the button is pressed to choose an actual floor to stop, the corresponding travel switch receives the signal, the link stopper bumps with the travel switch, the travel switch is cut off to make breakage stop the main shaft, and the compartment stops at the selected floor.

2. Non-winding type high-storey rescue lift of claim 1 wherein said There are there longitudinal guide rails installed underneath each of the compartment cabins.
